(19) United States
(12) Patent Application Publication
(10) Pub. No.: US 2024/0269603 A1
(43) Pub. Date: Aug. 15, 2024

(54) Reinforced Adsorbent Fibers and Applications

(71) Applicant: DECARBONTEK LLC, Woburn, MA (US)

(72) Inventor: Yong Ding, Waban, MA (US)

(21) Appl. No.: 18/425,475

(22) Filed: Jan. 29, 2024

Related U.S. Application Data
(60) Provisional application No. 63/483,827, filed on Feb. 8, 2023.

(51) Int. Cl. B01D 53/04; B01J 20/22; B01J 20/26; B01J 20/30

(52) U.S. Cl. CPC B01D 53/04; B01J 20/226; B01J 20/261; B01J 20/3007; B01J 20/3071; B01J 20/3078; B01D 2253/202; B01D 2253/204; B01D 2257/302; B01D 2257/304; B01D 2257/504

(57) ABSTRACT

A reinforced porous adsorbent fiber includes a reinforcing thread partially or completely embedded in a fiber adsorbent component, the latter including an active adsorbent such as a polyamine, an inorganic particulate adsorbent or an amine-modified inorganic particulate adsorbent, dispersed in a porous polymeric matrix. In specific examples, the thread-reinforced adsorbent fibers have attractive CO₂ adsorption/desorption performance, good tensile mechanical strength and/or flexibility.

### RELATED APPLICATIONS

This application claims the benefit under 35 USC 119(e) of U.S. Provisional Application No. 63/483,827, filed on Feb. 8, 2023, which is incorporated herein by reference in its entirety.

### BACKGROUND OF THE INVENTION

Carbon capture, utilization and storage (CCUS) generally refers to various technologies believed to play an important role in meeting global energy and climate goals. For instance, these technologies are considered by many as essential in keeping global temperature increases below 1.5 degrees centigrade (° C.).

CCUS involves capturing CO₂ from diluted gas streams, such as flue gas, air, etc. In the case of flue gas, the CO₂ concentration is in the range of 8 to 14 volume %; in the case of ambient atmospheric air, the CO₂ concentration is about 450 ppm. Currently, the upfront cost for CO₂ capture from a variety of streams is more than 80% of the total CCUS costs. In the case of direct air capture, the upfront cost for CO₂ capture is almost 99% of the total CCUS cost.

The primary method for CO₂ capture involves aqueous amine based solvent systems, such as Econamine FG+, KS-1, Oase Blue, and Cansolv. However, these amine-based systems suffer from high energy loss from regenerating the solvent (due to boiling and condensing 70% of water). Another significant energy penalty is the energy consumed for pumping a large amount of viscous solvents during solvent circulation. Furthermore, solvent based systems suffer from water loss and solvent loss and large amount of water and solvent-have to be replenished. Also, the solvent loss itself contributes to global emissions and is a potential health hazard. A discussion of disadvantages associated with these techniques can be found in review articles such as: Water-lean solvents for post-combustion CO₂ capture: fundamentals, uncertainties, opportunities, and outlook, by D. J. Heldebrant, P. K. Koech, V. Glezakou, R. Rousseaau, D. Malhotra, and D. C. Cantu, Chem. Rev., 2017, 117, page 9594; and Ionic liquid based CO₂ capture systems: structure, interaction and process, by S. Zeng, X. Zhang, L. Bai, X. Zhang, H. Wang, J. Wang, D. Bao, M. Li, X. Liu, and S. Zhang, Chem. Rev., 2017, 117, page 9625.

Solid adsorbents, such as metal organic frameworks (MOFs), diamine-appended MOFs, covalent organic frameworks (COFs), zeolites, porous silicas, porous polymeric powders, etc. have attracted significant attention, as they can potentially achieve a high adsorption efficiency with much less energy consumption. Conventional solid adsorbents are typically synthesized in the form of a crystalline powder with a crystallite size scale from nano- to several hundred microns.

Typically, however, powder solid adsorbents such as MOFs cannot be easily utilized in industrial applications. In fact, it has been reported that MOF powders can decrease the pressure within a pipeline, reducing, or even completely blocking the flow. Their use can also lead to abrasions due to powder blowing. A significant reduction of the pure MOF component also has been reported for powder application, along with other issues such as dustiness, clogging, and transfer and handling impediments. Sec, e.g., Binding materials for MOF monolith shaping processes: A review towards real life application, by V. Ntouros, I. Kousis, A. L. Pisello, and M. N. Assimakopoulos, Energies, 2022, 15(4), 1489.

To overcome such problems, solid adsorbent powders can be shaped into beads or pellets, typically from 1 to 6 mm in diameter. However, adsorbent beds that are packed with beads or pellets typically suffer from low bed packing, high pressure drop, and attrition. Both the pressure drop and the mass transfer resistance are strongly influenced by the size of the adsorbent beads. Changing the bead size has opposite effects on these two important factors. The interstitial space between the beads in the fixed bed is proportional to the size of the beads. Since the resistance to the fluid flow through the adsorbents is inversely proportional to the pore size of the packed bed, the use of small adsorbent beads will cause a high pressure drop. For this reason, the sizes of commercial adsorbent beads for fixed-bed operation are generally larger than 2 mm in average diameter. In addition, almost all the surface areas of commercial adsorbents are located at the interior of the adsorbent beads. For adsorption to occur, the adsorbate needs to be transported from the external fluid phase to the interior surface of the bead. The transport rate is influenced by two mass transfer mechanisms in series: (a) interfacial mass transfer, i.e., diffusion through the fluid boundary layer surrounding the external surface of the adsorbent bead; and (b) intraparticle mass transfer, i.e., diffusion through the internal pore space (micropores and macropores) of the bead to its interior surface where adsorption takes place. The size of the bead has significant effects on the rates of these two diffusion processes. Small beads offer large fluid/solid contact areas in the fixed bed for interfacial mass transfer and reduce the path length for the intra-particle diffusion. Hence, small adsorbent beads will increase the adsorption rate and result in a narrow mass transfer zone for fast and efficient operation of adsorption/desorption cycles. Thus, small adsorbent beads are desirable for efficient adsorption processes, but the minimum bead size is limited by acceptable hydrodynamic operating conditions of the fixed bed adsorber. That is, one wants to avoid fluidization and excessive pressure drop.

Structured adsorbents like monoliths and fibers offer improvement over traditional bead or pellet packed bed structure, as discussed, for example, in Critical comparison of structured contactors for adsorption based gas separation, by S. J. A. DeWitt, A. Sinha, J. Kalyanaraman, F. Zhang, M. J. Realff, and R. P. Lively, Annu. Rev. Chem. Biomol. Eng., 2018, 9, page 129.

The review articles entitled Structured adsorbents in gas separation processes by F. Rezaei and P. Webley, Sep. Purif. Techn., 2010, 70, page 243 and Structuring adsorbents and catalysts by processing of porous powders by F. Akhtar, L. Andersson, S. Ogunwumi, N. Hedin, and L. Bergstrom, J. Eur. Ceram. Soc., 2014, 34, page 1643 summarize research efforts towards structured adsorbents.

Current available adsorbent reactor configurations, such as fixed beds, moving beds, and fluidized beds, are summarized by C. Dhoke, A. Zaabout, S. Cloete, and S. Amin in the paper Review on reactor configurations for adsorption-based CO₂ capture, Ind. Eng. Chem. Res., 2021, 60, page 3779.

For carbon capture and storage (CCS), pressure-swing or temperature-swing packed bed adsorption employing adsorbent fibers offers several advantages compared with the monolith and conventional packed bed contactors. Generally, the pressure drops can be about ten to thirty times lower than those of packed beds even with high superficial velocity. The adsorbent fibers have a better mass/heat transfer coefficient than that of the packed bed and monolith, see Microporous materials in scalable shapes: Fiber sorbents, by Y. H. Lee, J. Jeong, K. Kim, T. Hyun, A. Jamal, D. Y. Koh, Chem. Mater., 2020, 32, 7081.

U.S. Pat. Nos. 8,133,308, 8,257,474 and 8,377,172 disclose hollow fiber adsorbents formed from a dope containing a water insoluble polymer and a particular inorganic adsorbent. However, these fibers lack the flexibility essential for winding the fibers into a structured device. U.S. Pat. No. 8,540,810 disclose an adsorption unit comprising an adsorbent hollow fiber which has at least two layers, one layer of adsorbent particles embedded in a polymeric matrix, and one layer of polyaniline that provides means for transmitting heat. These adsorbent fibers still suffer from low flexibility, as they exhibit a bending angle below 30°.

A composite fiber comprising adsorbent particles (at 50 weight %, abbreviated herein as “% w” or “% w”) in a polymeric matrix that comprises a polymer or blend of polymers including at least one thermoplastic polymer, is described in U.S. Pat. No. 10,525,399.

U.S. Pat. No. 9,114,364 discloses a hollow fiber, for adsorption or filtration, the fiber containing a tubular matrix having a first end and a second end, and a winding channel formed through the tubular matrix and extending between the first end and the second end. The disclosed adsorbent fiber has a curved configuration to promote mass transfer.

W. Quan, H. E. Holmes, F. Zhang, B. L. Hamlett, M. G. Finn, C. W. Abney, M. T. Kapelewski, S. C. Weston, R. P. Lively, and W. J. Koros describe adsorbent hollow fibers comprising polyether sulfone and a diamine appended Mg-MOF in Scalable formation of diamine-appended metal-organic framework hollow fiber sorbents for postcombustion CO₂ capture, JACS Au, 2022, 2, 1350.

US Patent Application Publication No. 2023/0011904 A1 discloses adsorbent fibers formed from a dope containing a water insoluble polymer and a polyamine via a dry-jet wet-quench spinning process. US Patent Application Publication No. 2023/0008877 A1 discloses modular devices and systems comprising adsorbent fibers.

Braid reinforcements have been used to prepare tubular braid reinforced hollow fiber membranes, as described in U.S. Pat. Nos. 3,676,193; 4,061,821; 5,472,607; 6,354,444; 7,267,872; 7,306,105; 8,529,814; 8,827,085; 8,999,454; 9,643,129; 10,046,281; and 10,434,477. Generally, these braid reinforced hollow fiber membranes address lateral mechanical strength, as discussed, for example in Effective parameters on fabrication and modification of braid hollow fiber membranes: a review, by A. Nazif, H. Karkhanechi, E. Saljoughi, S. M. Mousavi, and H. Matsuyama, Membranes, 2021, 11, 884; and Structure design and performance study on braid-reinforced cellulose acetate hollow fiber membranes, by Z. Fan, C. Xiao, H. Liu, Q. Huang, and J. Zhao, J. Membrane Sci., 2015, 486, 248.

### SUMMARY OF THE INVENTION

Although adsorbent loaded fibers are known, fibers with high adsorbent loadings generally lack the flexibility and axial mechanical strength (tensile strength). In addition, they are prone to breakage during handling. An approach to increase the mechanical properties of porous adsorbent fibers relies on increasing the mass of the matrix polymer. This, however, reduces the active adsorbent content in the adsorbent fiber, leading to added energy consumption. Moreover, the increased matrix polymer content reduces the surface area for CO₂ adsorption and increases the gas diffusion resistance.

While preparing tubular braid reinforced hollow fiber membranes has been reported, no such effort appears to have been attempted or even contemplated for fiber adsorbents. Furthermore, the concern addressed with existing braid reinforced hollow fiber membranes is that of lateral rather than axial strength.

Therefore, a need continues to exist for further purification methods and adsorbents suitable for the removal or capture of acid gases. A need also exists for strong, flexible adsorbent fibers that can be scaled-up to meet industrial requirements in a cost-effective manner.

The invention generally relates to approaches for removing an impurity (also referred to herein as a “contaminant”), an acid gas, for instance, from a medium containing the contaminant, e.g., a raw fluid stream.

In one of its aspects, the invention features a reinforced adsorbent fiber which includes a reinforcing thread that is partially or completely embedded in a porous solid adsorbent material such as a fiber adsorbent. A “fiber adsorbent” refers to a system comprising an active adsorbent, such as, for instance, solid porous adsorbent particles or polyamines, dispersed (e.g., homogeneously), in a matrix, often an open-pore matrix that can be made of a polymeric material.

In some embodiments, the reinforced adsorbent fibers described herein contain porous polymeric fibers loaded with porous particles such as, for example, zeolites, MOFs, COFs, porous aromatic frameworks (PAFs), activated alumina, carbon, graphene, silica, or layered double hydroxide (LDH).

In other embodiments, the reinforced adsorbent fibers include porous polymeric fibers loaded with amine-appended porous particulates, such as, for example, amine-modified zeolites, MOFs, COFs, PAFs, activated alumina, carbon, graphene, silica, or LDH.

In further embodiments, the adsorbent fiber component in the reinforced adsorbent fiber is a porous solid amine adsorbent that can be prepared by bringing into contact a first (e.g., dope) solution, including a water insoluble polymer and a water-soluble amine polymer, with an aqueous solution containing a multifunctional chemical agent. The first solution can be obtained by dissolving the water insoluble polymer and the water-soluble amine polymer in a polar solvent.

The reinforcing thread can be made from polymeric or natural fibers or yarns, from carbon, metals or metal alloys. The thread can add axial strength to the reinforced adsorbent fiber and can be braided or unbraided. Solid or hollow threads can be employed. In many cases, the reinforcing thread can be distinguished in some manner from the material encasing it. Its orientation can be parallel or substantially parallel to the length of the reinforced fiber. In a cross-sectional view of the reinforced fiber, the reinforcing thread can be centrally located or can be off-center.

The reinforced adsorbent fiber can be fabricated by a dry-wet solution spinning technique in which a dope solution is co-extruded with the reinforcing thread. Specific approaches include a dry-jet wet-quench spinning process (non-solvent induced phase inversion) or a temperature induced phase separation (TIPS). In illustrative examples, the feeding thread (e.g., braided or unbraided) is supplied through the center of a spinneret.

The reinforced adsorbent fibers can be hollow or solid (non-hollow). In many cases, they display enhanced axial strength (relative to a comparative adsorbent fiber that does not include a reinforcing thread). Flexibility is yet another property characterizing at least some of the reinforced adsorbent fibers described herein, as is porosity (which typically includes open-cell or interconnected pores).

The reinforced adsorbent fibers can be packaged into modular adsorption devices. An illustrative adsorption device (also referred to herein as a “cartridge”) includes multiple (a plurality of, i.e., two or more) adsorbent fibers that are laid parallel to or wound, e.g., helically, around a center tube. One or more cartridges can be assembled to form a module.

The reinforced adsorbent fibers, as well as cartridges and/or modules that include them, can be used to remove a contaminant from a fluid stream. In one example, the fluid stream is directed to a module containing at least one adsorbent device, the adsorbent device including reinforced adsorbent fibers. By bringing the fluid stream into contact with the reinforced adsorbent fibers at least a portion of the contaminant becomes adsorbed by the reinforced adsorbent fibers, generating a purified stream that can be collected from the module.

For many applications, the reinforced adsorbent fibers can be regenerated by desorbing trapped impurities using, for instance, heat, reduced pressure or vacuum, or a combination thereof.

Practicing embodiments of the invention offers many advantages. For example, at least some of the reinforced adsorbent fibers described herein provide good fiber flexibility and/or enhanced axial mechanical strength. Due to such properties, the reinforced fibers can be incorporated in adsorbent devices and/or modules.

In many cases, the reinforced adsorbent fibers can be used to remove a contaminant, in particular an acid gas such as CO₂, H₂S, SO₂, from a flue gas, biogas, hydrogen gas, natural gas, air or another fluid streams. Practicing the invention can be very attractive when handling low concentration separations, and can offer high recoveries, less energy consumption and/or better economics in applications such as direct air capture, removal of CO₂ for LNG production, and CO₂ capture from flue gases. Employing carbon or metallic reinforcing threads can facilitate the contaminant desorption/fiber regeneration process.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 illustrates the cross sections of feasible threads or braided threads;

FIG. 2 illustrates a reinforced adsorbent fiber spinning set up via the dry-jet wet-quench process;

FIG. 3 is a photograph of the cross section of a reinforced adsorbent fiber containing PEI having an embedded thread;

FIG. 4 is a TGA graph showing the activation of a thread reinforced adsorbent fiber at 110 degrees centigrade (° C.) and the adsorption of CO₂ at 30° C.; the thread reinforced adsorbent fiber was prepared by contacting a dope solution, containing PAN and PEI, with a 5% MgSO₄ solution;

FIG. 5 is a photograph of the cross section of a reinforced adsorbent fiber containing 75% w of CALF-20 embedded in a porous PAN matrix;

FIG. 6 is a photograph of a reinforced adsorbent fiber containing 75% w of CALF-20 that is helically wound around a metal rod (⅜″ OD);

FIG. 7 shows the pure CO₂ adsorption profiles for CALF-20 powder, 75% w of CALF-20/PAN fiber without thread and 75% w of CALF-20/PAN fiber reinforced by a polyester thread.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention generally relates to reinforced adsorbent fibers, and methods for making and using them. Reinforced adsorbent fibers include a reinforcing thread embedded, partially or completely, in a solid adsorbent material that, in many embodiments, is porous. As used herein, the term “fiber adsorbent” or “adsorbent fiber” refers to a system in which a porous adsorbent material, typically in particulate form, or polyamines is/are dispersed, e.g., homogeneously, throughout a matrix, e.g., an open-pore matrix, often a polymeric open-pore matrix. Adsorbent fibers can be produced via conventional dry-jet wet-quench spinning techniques and can be manufactured in various structures such as monolithic (solid or non-hollow), hollow, dual layered, inverse fiber, to name a few, typically depending on the dope compositions and spinning parameters.

A reinforced adsorbent fiber, also referred to herein as “thread-reinforced adsorbent fiber” includes a reinforcing thread that is partially or completely embedded (buried or encased), within the fiber adsorbent component of the reinforced fiber.

The reinforcing thread is embedded lengthwise, in an orientation that can be parallel or substantially parallel to the reinforced fiber itself. In a cross-sectional view of the reinforced adsorbent fiber, the reinforcing thread can be disposed off-center or centrally. In some embodiments, this placement remains uniform over the entire length of the reinforced adsorbent fiber. In others, the placement varies along the length of the reinforced adsorbent fiber. For instance, the reinforcing thread can be centrally disposed over a certain segment and somewhat (slightly or more than slightly) off-center over other segment(s). In a partially embedded configuration, an outer surface of the reinforcing thread forms the outer surface of the reinforced adsorbent fiber.

Reinforcing threads that can be employed are in the form of monofilaments, multifilaments or a mixture of both. Some implementations utilize a single thread. Others utilize multiple (two or more) threads that can be aligned or can be braided together.

The cross section of the reinforcing thread can be solid or hollow. In one example, a hollow adsorbent fiber is fabricated using a hollow tubular braid. This type of reinforcing thread can be obtained from a braiding machine or can be prepared as described in U.S. Pat. Nos. 8,827,085 and 10,906,006.

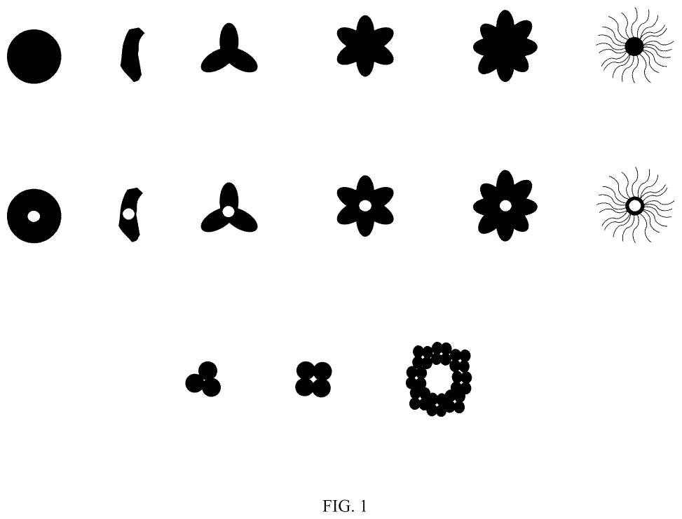

Any suitable cross-sectional shape can be employed. Examples include but are not limited to round, oval, star-like or other regular or irregular shapes. Some possible options are illustrated in FIG. 1.

The reinforcing thread can have a diameter sized according to the desired thickness of the reinforced adsorbent fiber. In one example, the reinforcing thread has a thickness within a range of from about 0.1 mm to about 2 mm.

The reinforcing thread can be made from natural (cotton, silk, wool, etc.), polymeric (polyethylene, polypropylene, polyesters, nylon, polyacrylonitrile, cellulose acetate, polyvinylidene fluoride (PVDF), polyimides, polysulfone, polyphenylene oxide, polyaramides, and so forth) fibers or yarns, from metals (such as copper, aluminum), metal alloys, e.g., steel or bimetallics (such as nichrome), from fiberglass, or carbon (such as from carbon fiber). In cases in which a polymeric thread is utilized, the reinforcing thread can be made from a homopolymer, copolymer, a polymer blend, etc. Suitable threads can be obtained commercially (e.g., from Toray Industries Inc, Indorama Corporation Pte Ltd, Weiqiao Textile Company Limited, Far Eastern New Century, and Unifi Inc., etc.), or can be custom-made. Braided threads, for instance, can be prepared using a braiding machine, in a process such as described in the U.S. Pat. No. 9,643,129.

Some applications utilize a reinforcing thread having the same chemical composition as the chemical composition of the polymer utilized in manufacturing the porous adsorbent fiber component, e.g., a polymer employed to form the open-pore polymer matrix in the adsorbent fiber. Utilizing the same chemical composition for the reinforcing thread and the adsorbent matrix is believed to enhance the adhesion between the thread and the fiber adsorbent in which the thread is partially or completely embedded.

In one implementation, the reinforcing thread is made from metals or metal alloys, such as, for example, steel, aluminum, copper, nichrome, etc. In another, the reinforcing thread is made from fiber glass, or carbon fibers.

If a metallic or carbon reinforcing thread is utilized, the thread can serve one or more functions. For instance, the metallic or carbon reinforcing thread can provide axial mechanical strength for the reinforced fiber and/or can transmit an electric current, thus supplying heat through the thread during a fiber regeneration operation. In some implementations, the electricity is derived from a renewable source, such as solar, or wind.

Selecting a suitable reinforcing thread can take into consideration factors such as mechanical strength, compatibility between the thread and the fiber adsorbent component in the reinforced fiber (to reduce or minimizing delamination occurrences), the maximum regeneration temperature and so forth. In specific illustrations, the thread is a monofilament made from polyethylene terephthalate (PET), polyacrylonitrile (PAN), polyimide, polyamide, cotton, steel, copper, aluminum, nichrome, carbon or any combination thereof.

In many embodiments, the fiber adsorbent component that partially or completely encases the reinforcing thread contains an active adsorbent material in the form of solid adsorbent particles.

Adsorbent particulate materials that can be employed include, for instance, those known in adsorbent-based fluid separations, in particular gas separations. Non-limiting options include zeolites, MOFs, COFs, PAFs, activated alumina, carbon, graphene, silica, layered double hydroxide (LDH), and others.

The MOF particulate material can be a single MOF or a mixture of MOFs independently selected from the group consisting of CALF-20, CALF-15, UIO-66, UIO-66-NH₂, UIO-67, UIO-68, IISERP-MOF-2, MIL-53, MIL-88, MIL-96, MIL-101, MIL-140L, MIL-160, MUF-15, MUF-16, ZIF-7, ZiF-8, ZIF-9, ZIF-10, ZIF-12, ZIF-68, ZIF-69, ZIF-70, ZIF-78, ZIF-79, ZIF-81, ZIF-82, ZIF-90, MOF-2, MOF-3, MOF-4, MOF-5, MOF-70, MOF-73, MOF-74, MOF-75, MOF-76, MOF-177, MOF-303, MOF-505, MOF-80, MOF-808, CAU-10, CAU-10-H, Al(OH) fumarate, Al-formate, Mg-formate, Zr-fumarate, HKUST-1, Fe-BTC, PCN-224, PCN-250, UTSA-16, MIL-120(Al), and Mg(H2 gal).

In some implementations, the adsorbent is functionalized (modified, with suitable functional groups, often amine-containing functional groups. As an example, an amine-functionalized magnesium MOF is disclosed in U.S. Pat. Nos. 9,861,953 and 10,137,430 (with the title Alkylamine functionalized metal-organic frameworks for composite gas separations). These documents describe functionalized metal-organic framework adsorbents with ligands containing basic nitrogen groups such as alkylamines and alkyldiamines appended to the metal centers.

In specific examples the active adsorbent is a zinc MOF such as CALF-20, disclosed in U.S. Pat. No. 11,230,562 (with the title Synthesis of zinc MOF materials); a zeolitic imidazolate framework, such as ZIF-94 (described, for example, in the paper titled CO₂ capture from high humidity flue gas using a stable metal-organic framework, by Q. Wang et. al, Molecules, 2022, 27, 5608; or an amine-appended magnesium MOF such as epn-grafted Mg₂(dobpdc) (epn=1-ethylpropane-1,3-diamine), disclosed, for example in U.S. Pat. Nos. 9,861,953 and 10,137,430.

The solid adsorbent particles can have a particle size of less than or equal to 100 μm, typically less than or equal to 10 μm, and sometimes even less than or equal to 1 μm. The amount of solid particles in the adsorbent fiber can vary from 25 to 90% by weight (expressed as % w), typically from 30% w to 80% w. In illustrative examples, the solid particles are present in the fiber in an amount within a range of from about 30 to about: 40, 50, 60, or 70 w %; from about 40 to about: 50, 60, 70 or 80 w %; from about 50 to about: 60, 70 or 80 w %; from about 60 to about: 70 or 80 w %; from about 70 to about 80 w %.

One embodiment of the invention relates to a reinforced adsorbent fiber in which the active adsorbent is an amine-containing compound (a substance that includes functional groups such as —NH₂, —RNH, or —RR′N), such as, for instance, a water-soluble amine-containing polymer. As used herein, the term “amine-containing polymer” or “amine polymer” refers to polymers that contain —NH₂, —RNH, or —RR′N functional groups attached to/separated by —CH₂CH₂—, —CH₂CH₂CH₂—, or —CH₂CH₂CH₂CH₂—. The R and R′ groups can be methyl, ethyl, propyl, etc. groups, and can be the same or different.

The water-soluble amine polymer can be provided in a wide range of molecular weights, from about 400 to about 10,000,000, for example. Some implementations utilize a water-soluble amine polymer within a range of from about 1,000 to about 1,000,000.

As described, for instance, in U.S. patent application Ser. No. 17/859,139 (published on Jan. 12, 2023 as US 2023/0011904 A1) and International Application No. PCT/US22/36293 (published on Jan. 19, 2023 as WO 2023/287632 A1), both having the title Porous Solid Amine Adsorbents and Applications and both filed on Jul. 7, 2022, the entire contents of these documents being incorporated herein by this reference, the water-soluble amine polymer can be provided, along with other constituents, in a first solution (mixture or blend), also referred to herein as a “dope” solution or simply “dope”. In the context of hollow fiber manufacture, a “dope” is a blend of polymers, solvent and, optionally, other constituents, that passes through the annular space of a spinneret to form a nascent hollow fiber.

In one implementation, the water-soluble amine compound (e.g., polymer) includes a unit skeletal structure represented by Formula 1:

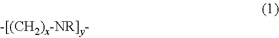

In the unit skeletal structure, R may be hydrogen or a branched chain; x is an integer of 1 to 4, and y is an integer of 2 to 1,000,000. In specific implementations, the amine compound is a linear or branched polyethylenimine (for x=2) or a linear or branched polypropylenimine (for x=3).

In another implementation, the water-soluble amine compound (e.g., polymer) includes a structure represented by Formula 2:

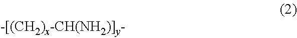

where x is an integer of 1 to 4 and y is an integer of 2 to 1,000,000. In specific implementations, the amine compound represented by Formula 2 is a polyvinylamine (in the case of x=1).

The water-soluble amine polymer can be partially crosslinked by reacting it with a crosslinking agent to increase the molecular weight. Partial crosslinking is beneficial in some cases to increase (dope) solution viscosity and final adsorbent adsorption capacity. The degree of partial crosslinking is controlled below the gelling point of the solution and is often achieved by adding to the solution with a controlled amount of crosslinking agent. Suitable crosslinking agents include glyoxal, glutaraldehyde, bisphenol A diepoxy, isocynate, metal cations, and the like. In one illustrative embodiment, the crosslinking agent is bisphenol A diepoxy.

The amount of the water-soluble amine compound can be within a range of from about 5 to about 50% based on the total weight of the first (e.g., dope) solution.

Also present in the dope solution are matrix polymers that are water insoluble. These polymers can be natural or synthetic. Examples of natural polymers include lignin, cellulose, cellulose derivatives, (such as cellulose acetates, for instance), and others. Examples of synthetic polymers include polyacrylonitrile, poly(methyl methacrylate), polystyrene, poly(ethylene terephthalate), aromatic polyamides, aliphatic polyamides, polyimides, polyesters, polyetherketones, polysulfone, polyethersulfones, polyetheresters, polysulfones, polyvinyl fluoride, polyvinyldifluoride, polyvinylchloride, polyvinyl butyral, polybenzimidazoles, polybenzoxazoles, polyazoaraomatics, poly(2,6-dimethylphenylene oxide), polyphenylene oxides, polyureas, polyurethanes, polyhydrazides, polyazomethines, polyacetals, polyquinoxaline, polyamideesters, polyacetylenes, polymer with intrinsic porosities (PIMs), polyesters, any combinations (blends) or copolymers thereof.

The solvents used for making the dope solution can include non-polar solvents, polar protic solvents as well as polar aprotic solvents, such as N-methyl-2-pyrrolidone (NMP), N,N-dimethylformamide (DMF), N,N-dimethylacetamide (DMAc), and dimethylsufoxide (DMSO), and combination thereof.

The solvent may also include a non-solvent. The nonsolvent component can be liquid or solid and can be selected to serve any number of functions: viscosity modifications, imparting porosity and/or other properties to the adsorbent product, or for other purposes. Examples of nonsolvents that can be employed include but are not limited to water, aliphatic alcohols, particularly polyhydric alcohols such as ethylene glycol, glycerine, etc., polyethylene oxides and polypropylene oxides, polyvinylalcohol, polyvinylpyrrolidone, surfactants such as alkylaryl polyether alcohols, alkyl sulfates, alkylarylsulfates, etc., triethylphosphate, formamide, and salts such as lithium chloride, etc. Combinations of nonsolvents also can be used. The nature and amount of the nonsolvent can depend on desired product properties, process and/or equipment parameters or other factors. In general, the amount of nonsolvent can be within a range of from about 0% to about 30% based on the weight of the dope solution.

As described in U.S. patent application Ser. No. 17/859,139 (published as US 2023/0011904) and International Application No. PCT/US22/36293 (published as WO2023/287632), porous solid adsorbents can be prepared by bringing into contact a first solution (such as the dope solution described above) with a second solution. In one example, the second solution is an aqueous solution containing a multivalent (multifunctional) acid, i.e., an acid having two or more acid functional groups. In another example, the second solution is an aqueous solution containing a multivalent metal ion, such as Ca²⁺, Cu²⁺, Zn²⁺, and Mg²⁺.

The aqueous solution can include water in an amount of at least 80% based on the total weight of the aqueous solution, preferably in an amount that is equal or greater than 95 w %.

The multifunctional acid can be an inorganic acid, such as sulfuric acid or phosphoric acid, or an organic acid. Examples of suitable multifunctional organic acids (having two or more —COOH groups) include oxalic acid, citric acid, malic acid, tartaric acid, humic acid, dithiodipropionic acid, succinic acid, sulfosuccinic acid, phytic acid, trans aconitic acid, polyacrylic acid and its copolymers, polyvinylphosphonic acid and its copolymers, polystyrene sulfonic acid and its copolymers, polystyrene phosphonic acid and its copolymers, polystyrene carboxylic acid and its copolymers, and the like, or any mixtures thereof.

In one example, the acid concentration in the aqueous solution is in the range of 0.01% to 30%, preferably in the range of 0.1% to 10% relative to the total weight of the aqueous solution.

In some cases, the second solution is simply an acid-water solution. In others, the second solution further includes one or more additive(s).

Second solutions that contain a metal ion typically employ a metal ion that can form a multiligand metal complex. The metal ion can be a component in a multifunctional metal salt.

Examples of multifunctional metal ions that can be used include Cu⁺, Cu²⁺, Ca²⁺, Ni²⁺, Zn²⁺, Pd²⁺, Mg²⁺, Co²⁺, Cr²⁺, Fe²⁺, Fe³⁺, and others. The selection of the metal ion concentration will depend on the nature of the metal ion, the dwelling time of the first solution (e.g., dope) in the metal ion solution, solution temperature, the desired metal concentration in the final adsorbents or other factors. The use of metal ions can be advantageous due to their low cost and, in some cases, synergistic CO₂ adsorption effect.

In some implementations, the concentration of the metal ions in the solution is in the range of 0.001M to 5M, preferably in the range of 0.01M to 2M.

Without wishing to be bound by any particular theory or interpretation, it is believed that once the first solution (e.g., dope) is brought into contact with the aqueous solution containing a “multifunctional chemical agent” (e.g., a multifunctional acid or metal salt), the water insoluble polymer chain is frozen into a solid state by a non-solvent induced phase inversion, while the water soluble amine compound is frozen into a solid state by a rapid crosslinking reaction between at least some of the amine functional groups and the multifunctional chemical agent. It is further believed that without the multifunctional chemical agent, the water-soluble amine compound would become rapidly diffused into the water solvent precluding the formation of a functional adsorbent.

Reinforced adsorbent fibers can be manufactured using various techniques.

A dry-jet wet-quench spinning process (non-solvent induced phase separation or NIPS), for example, involves feeding a reinforcing thread (e.g., unbraided or braided) through the center of an extrusion die or spinneret. A polymer can be dissolved in a solvent first, then an active adsorbent in powder form, with a particle size of less than or equal to 100 μm, for instance, can be added, together with optional additives, such as CaCl₂), LiCl, polyethylene oxide, etc. The dope solution can be degassed under heat and/or vacuum prior to extrusion through a die or spinneret.

The reinforced adsorbent fibers also can be manufactured via a temperature induced phase separation (TIPS) process by feeding a reinforcing fiber (e.g., unbraided or braided) through the center of the extrusion die or spinneret. A blend of polymers and the adsorbent particles is heated above the melting temperatures of the polymers, followed by extrusion, an operation during which the adsorbent and molten polymers pass through an extrusion die or spinneret.

The nascent fiber emerging from the die or spinneret can be allowed to pass through (or traverse) a cooling medium such as water/or air so that the nascent fiber solidifies.

For active adsorbents that are not provided as solid particles, the reinforced adsorbent fiber can be fabricated using a dry-wet solution spinning technique in which a dope solution (containing, for example, a water insoluble polymer and an active adsorbent, e.g., a water-soluble amine-containing polymer) is fed through an annular region of a spinneret and co-extruded with a reinforcing thread typically fed through the center of the spinneret. In one example, the reinforcing thread is a hollow tubular braid. The nascent fiber exiting the spinneret can be passed through an air gap, then into a coagulation medium (bath) where the fiber adsorbent component becomes solidified. The coagulation medium can include a non-solvent or a poor solvent for the polymer while at the same time being a good solvent for the solvent within the dope solution. For preparing reinforced adsorbent fiber that include a porous solid amine adsorbent, the coagulating medium can include a multifunctional agent, a multivalent metal ion, for example.

From the coagulation bath, the solidified reinforced adsorbent fiber can be further processed by conducting one or more operations such as washing, heat treatment, drying, to name a few. Solidified fiber may be pulled from the coagulation bath onto and around a rotating barrel, then directed into the washing medium. Pulling and piddling (a technique described, for example in U.S. Pat. No. 8,753,741) into a washing barrel also can be employed.

For reinforced fibers that utilize a braided thread, the fiber manufacturing process can include a step that involves preparing the braided thread, using, for instance, a braiding machine, in a process such as described in the U.S. Pat. No. 9,643,129.

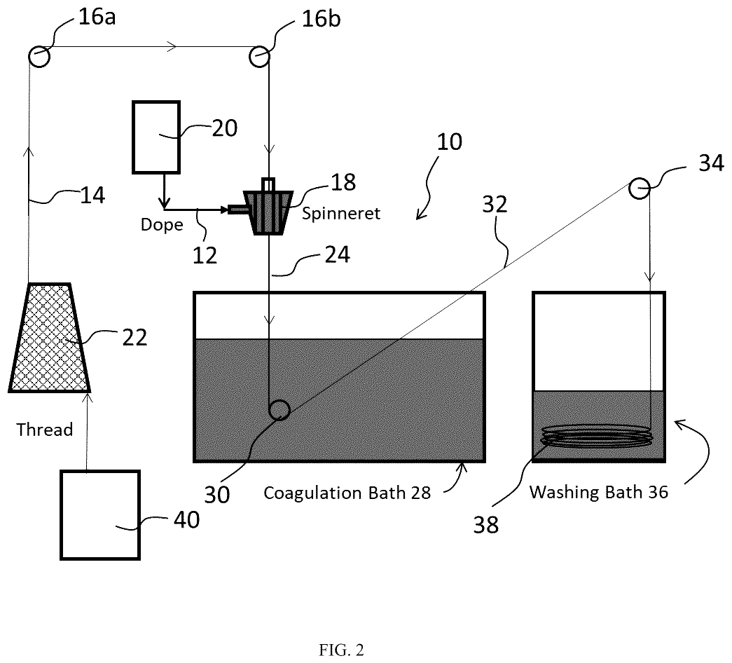

An illustrative reinforced fiber spinning process and system are depicted in FIG. 2. The process shown in this figure proceeds in the direction of the arrows and generally involves several steps conducted in various components of apparatus 10. To start, dope solution 12 and reinforcing thread 14 (the latter being guided by elements 16a, 16b, which can be rollers or tension control devices) are fed to spinneret 18 for co-extrusion. In one example, dope solution 12 is supplied (e.g., by pumping) from a reservoir 20, while reinforcing thread 14 is unspooled from a suitable thread-winding arrangement 22.

To prepare a reinforced hollow adsorbent fiber, the spinneret can have a tube-in-tube configuration, the dope solution being fed to the annular space between the inner and the outer tube. Thread 14 can be a solid or a hollow braid fed to the center of the spinneret. A bore fluid can be used but is not required.

Obtaining reinforced hollow adsorbent fibers of desired morphologies or properties may depend on factors such as spinneret design, dope and bore fluid flow rates and/or physical properties, air gap dimensions, bath conditions, shear forces within the spinneret, ratios of dope to bore fluid volumetric flow rates, draw ratios and so forth. U.S. Pat. No. 5,181,940, the entire contents of which are incorporated herein by this reference, provides details on the manufacture of hollow fiber membranes that may be found applicable.

Solid (non-hollow) reinforced adsorbent fibers can also be prepared by feeding the dope and reinforcing thread through a needle arrangement.

Nascent fiber 24 emerges from the spinneret, traverses an air gap and is immersed into coagulation bath 28. Employing guiding element 30 (e.g., a roller or a tension control device), the resulting reinforced fiber 32 is pulled from the coagulation bath and guided by rotating arrangement 34 (or another suitable device) to washing bath 36, where the solvent is removed as completely as possible, using a suitable solvent such as water or alcohol. The reinforced thread 38 can be collected from the washing bath for use or further processing.

Drying, for example, can be conducted under ambient conditions or by supplying heat, e.g., in an oven at temperatures such as from 50° C. to 150° C.

In some cases, heat treatment (in a suitable oven or a in suitable fluid, such as a water bath, for instance) can be undertaken, e.g., to impart desired mechanical properties to the product reinforced adsorbent fiber. Stepwise heating, followed by plateau temperature maintenance, optionally interspersed with one or more cooling and reheating periods, can be employed in some cases. Temperatures typically are above room temperature and are often at least 10° C. below the glass transition temperature of the water insoluble polymer. In an illustrative example, a reinforced fiber containing a PEI-based porous solid amine adsorbent is heated to and maintained at 100° C. for a period of 24 hours, then cooled to room temperature over a period of 4 hours. for example.

Apparatus 10 can include optional braiding station 40 in an approach that provides an integrated system for the manufacture of adsorbent fibers reinforced with a braided thread, e.g., a hollow, tubular braid.

The overall mass of the reinforcing thread in the final dry adsorbent fiber is typically less than 30% by weight, preferably less than 20% by weight, more preferably, less than 10% by weight. In many implementations, the reinforcing thread is present in the final adsorbent fiber product in a range (by weight, expressed as “% w”) of from about 2% w to about 20% w, e.g., in arrange of from about 2% w to about 10% w. In specific examples, the amount of reinforcing thread is from about 2% w to about: 3, 4, 5, 6, 7, 8 or 9% w: from about 3% w to about: 4, 5, 6, 7, 8, 9, 10% w; from about 4% w to about: 5, 6, 7, 8, 9 or 10% w; from about 5% w to about: 6, 7, 8, 9 or 10% w; from about 6% w to about: 7, 8, 9 or 10% w; from about 7% w to about: 8, 9 or 10% w; from about 8% w to about: 9 or 10% w; from about 9% w to about 0% w. Other values can be employed, as determined, for instance by routine experimentation.

Reinforced hollow adsorbent fibers can be prepared in any desired inner and/or outer diameters. In one example, the reinforced adsorbent fiber has a thickness (outer diameter) within a range of from about 0.1 mm to about 6 mm. Inner diameters can be within a range of from about 0.05 mm to about 3 mm.

The product reinforced adsorbent fibers described herein can have a density within a range of from about 0.2 g/cm³ to about 1 g/cm³, preferably from about 0.3 g/cm³ to about 0.8 g/cm³.

Many of the properties characterizing the product reinforced adsorbent fibers can be obtained by selecting or adjusting the equipment design, the process conditions or other factors. Porosity attributes, for instance, can be tailored by solvent concentration, nonsolvent, other additive and the concentration of the crosslinking agent or by other approaches.

After coagulation, many of the product reinforced adsorbent fiber can be best described as having an open-cell or interconnected structure. Specifically, the polymer matrix encapsulates the active adsorbents in an open-cell arrangement, without blocking the active adsorbents, thus promoting good mass transport.

Total porosity amounts can be within a range of from about 20% to about 80%, preferably from about 30% to about 70% by volume. In specific examples, the total porosity is within a range from about 30 to about: 40, 50 or 60 vol %; from about 40 to about: 50, 60 or 70 vol %; from about 50 to about: 60 or 70 vol %; form about 60 to about 70 vol %.

Pore size of the polymer matrix can vary and adsorbents described herein can include macroporosity, microporosity and/or nanoporosity. An ideal polymer matrix contains interconnected pores with the active adsorbent enclosed inside the matrix; the matrix does not contribute to the transport resistance for the contaminant to be removed. The type of matrix porosity most relevant with respect to the removal of an acid gas such as carbon dioxide from a flue stream is macroporosity and/or microporosity. Surface porosity can be within an illustrative range of 1% to 60% by area, such as from about 10% to about: 20%, 30%, 40%, 50% or 60% by area; from about 20% to about: 30%, 40%, 50% or 60% by area; from about 30% to about: 40%, 50% or 60% by area; from about 40% to about: 50% or 60% by area; from about 50% to about 60% by area.

The reinforced porous adsorbent fibers can be characterized by analytical techniques such as nitrogen BET (Brunauer-Emmett-Teller), scanning electron microscopy (SEM), atomic force microscopy (AFM), Fourier transform infrared spectrometry (FTIR), or others, as currently known in the art or developed in the future. Standard methods or protocols (e.g., thermal gravity analysis, adsorption column) can be employed to assess the properties of the reinforced adsorbent fibers.

Advantageously, methods described herein can produce reinforced adsorbent fibers that are self-supporting (also referred to as “free-standing”), a property describing a material or an article that does not require an external supporting structure to prevent it from collapsing or crumbling.

A main concern in hollow fiber membrane technology is lateral mechanical strength. This is because the productivity and separation efficiency of a hollow fiber membrane rely on the pressure differential between the outside pressure and the bore side pressure (lateral pressure differential). Since the lateral pressure differential can cause the hollow fiber membrane to collapse, the goal of existing reinforced hollow fiber membranes is to maintain the lateral mechanic strength of the hollow fiber wall. For adsorbent fibers, however, there is no such pressure differential between the outer (shell) side of the fiber and its inner (bore) side. As a result, lateral mechanical strength is of little or no concern for the adsorbent fibers described herein.

A very desirable property, however, is axial (tensile) strength. In many embodiments, the reinforced adsorbent fiber has an axial strength that is greater than the axial strength of a comparative adsorbent fiber made of the same adsorbent material but without a reinforcing thread. Axial strength (tensile strength) of the adsorbent fiber can be determined utilizing standard tensile strength measurement instrument, such as the ones manufactured by Instron. Illustrative reinforced adsorbent fibers have a tensile strength of at least about 2 MPa.

In addition or in the alternative, another property of great interest here is the flexibility of the reinforced adsorbent fibers. Empirically, this property can be measured by bending the fibers. If a fiber can form a closed loop, the fiber can be said to be flexible. The more flexible the fiber is, the smaller the loop that can be formed. Reinforced adsorbent fibers that are sufficiently flexible to be wound around a core member to form an adsorption device (as further described below) are particularly useful. In one example, the reinforced adsorbent fiber can be coiled around a core member with a diameter no greater than 1 cm to prepare a helically wound adsorption cartridge.

For many applications, the reinforced adsorbent fibers described herein are packaged into modular adsorption devices. An illustrative adsorption device (also referred to herein as a “cartridge”) includes multiple (a plurality of, i.e., two or more) adsorbent fibers that are laid parallel to or wound, e.g., helically, around a center tube. One or more cartridges can be assembled into a module. In illustrative examples, a module for purifying a raw fluid (an acid gas, for instance) includes at least two adsorbent devices that are installed in a vessel in series or in parallel. Operations can be conducted in an axial or cross flow arrangement. Either shell side or bore side feeding can be employed. In some implementations, a module is provided with one or more heating elements that can be used to release adsorbed contaminant, regenerating the reinforced adsorbent fibers. Various cartridge and/or module configurations that can be employed are described, for instance, in U.S. Nonprovisional patent application Ser. No. 17/859,121 (published on Jan. 12, 2023, as US 2023/0008877 A1) and in International Patent Application No. PCT/US22/36288 (published on Jan. 19, 2023, as WO 2023/287630 A1), both having the title Modular Adsorbent Devices and Applications, both being incorporated herein by this reference in their entirety.

The reinforced adsorbent fibers described herein, assembled into a cartridge and/or module, for example, can be used to remove an acid gas from a fluid stream, e.g., a flue gas stream. For example, a fluid stream containing an acid gas (CO₂, for instance) is brought into contact with the reinforced adsorbent fiber. As at least a portion of the acid gas (e.g., CO₂) becomes adsorbed by the porous solid adsorbent, the fluid stream is depleted in the acid gas (e.g., CO₂), generating a stream that is purified relative to the acid gas.

Reinforced adsorbent fibers containing a contaminant such as an acid gas (e.g., CO₂) can be regenerated for reuse or for environmentally safe disposal. Various methods can be employed, using heat, vacuum, lower pressure, or any combination thereof. If the regeneration technique relies on heat, the desorption process can be a temperature swing adsorption (TSA) method, while many processes based on lowered pressures are known as pressure swing adsorptions (PSA). Another useful technique that can be employed to release adsorbed species from the reinforced adsorbent fibers involves both heating and vacuum, the process being known as temperature-vacuum swing adsorption or TVSA. These techniques are well known in the art (see, e.g., U.S. Pat. Nos. 9,457,340, and 8,974,577, the entire contents of both being incorporated herein by this reference).

For reinforced adsorbent fibers that employ a carbon or metal reinforcing thread regeneration can be conducted by supplying electricity to the thread, thus heating the thread to desorb the trapped contaminant. The energy can be supplied from a conventional energy source or it can be derived from renewable (wind, solar) energy sources.

With respect to performance, the reinforced adsorbent fibers described herein can have good CO₂ adsorption/desorption properties. Uptake of CO₂ from a pure CO₂ stream can be from 0.03 g/g of fiber to 0.30 g/g of fiber. The adsorption can occur rapidly, e.g., within a time frame within a range of from about 1 min to about 10 min. In the purification of a stream containing dilute CO₂ amounts (e.g., no greater than 1% by volume), the reinforced adsorbent fibers can produce a purified stream with CO₂ levels reduced by 80% or more. Desorption can be completed rapidly (often within a time period of 1 min to 10 min).

Reinforced adsorbent fibers such as described herein also can find applications in the direct removal of an acid gas from an ambient atmosphere. Some approaches that can be employed to capture CO₂ from the atmosphere typically rely on a blower to circulate the air through a device including the reinforced adsorbent fiber. As CO₂ is adsorbed, clean air is released. Once the reinforced adsorbent fibers are saturated with CO₂, the air circulation can be directed to another adsorbent device, and the current adsorbent is regenerated by heat, or vacuum, or a combination of both. The heat source can be from renewable energy sources, such as solar or wind energy.

The carbon dioxide released from the reinforced adsorbent fibers described herein can be utilized for enhanced oil recovery, to prepare synthetic fuels, such as methanol, methane, jet fuels, etc. In some embodiments, the carbon dioxide is injected for permanent storage.

The invention is further illustrated by the following non-limiting examples.

### Example 1

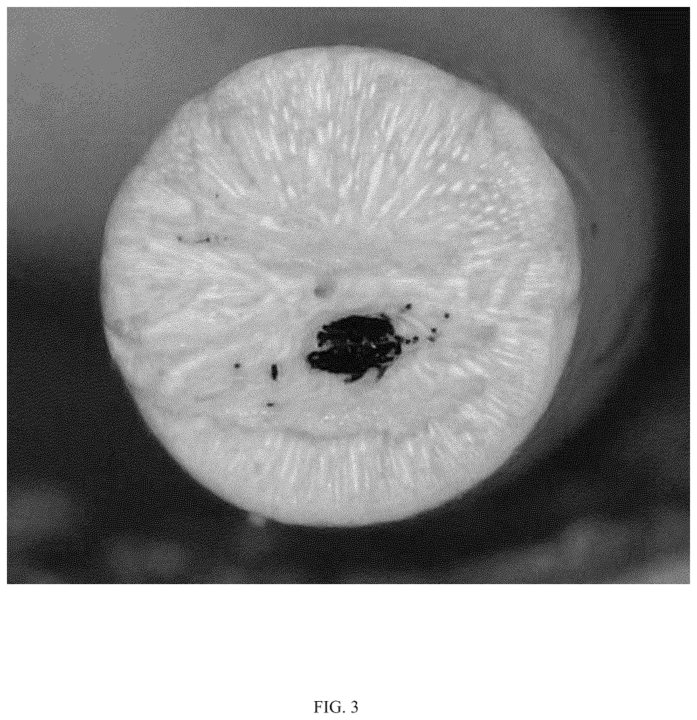

A dope solution was prepared by dissolving 10.0 g of polyacrylonitrile and 10.0 g of polyethylenimine (with MW of 25,000) in 45.0 g of NMP. After degassing, the dope solution was transferred into a homemade fiber spinning apparatus equipped with a spinneret and a polyester thread feeder. The specific reinforcing thread employed was black, TEX21 spun polyester thread, with a diameter of about 0.005 inch. The dope solution and the thread were extruded from the spinneret to form a nascent fiber and the nascent fiber was delivered into a deionized (DI) water solution containing 5% by weight of MgSO₄. The fiber was further soaked in water for 24 hours (to remove the NMP solvent), after which it was air dried. A photograph of a cross section of the fiber is presented in FIG. 3. The black region in the cross section is the cross section of the reinforcing polyester thread.

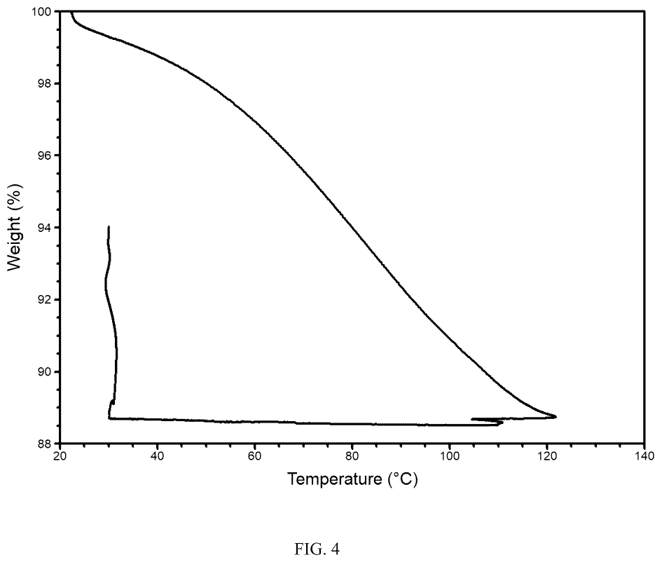

A section of the fiber was tested with a TGA instrument for its CO₂ adsorption property. The fiber was first heated to 110° C. and held at 110° C. for 30 min to activate the fiber under nitrogen. This was followed by cooling the activated fiber to 30° C. under nitrogen. The fiber was then exposed to a dry CO₂ gas stream for 30 min. The weight gain of the fiber after the CO₂ exposure was 6.3% by weight. A TGA graph showing the activation of the adsorbent fiber at 110° C. and the adsorption of CO₂ at 30° C. is shown in FIG. 4.

### Example 2 (Comparative)

A dope solution was prepared by mixing 21.3 g of CALF-20 powder, 7.33 g of polyacrylonitrile and 40.0 g of NMP. After degassing, the dope solution was transferred into a homemade fiber spinning apparatus equipped with a spinneret. The dope solution was extruded from the spinneret to form a nascent fiber and the nascent fiber was delivered into deionized (DI) water. The fiber was further soaked in water for 24 hours (to remove the NMP solvent), after which it was air dried.

A section of the fiber was tested with a TGA instrument for its CO₂ adsorption properties. The fiber was first heated to 110° C. and held at 110° C. for 30 min to activate the fiber under nitrogen. This was followed by cooling the activated fiber to 30° C. under nitrogen. The fiber was then exposed to a dry CO₂ gas stream for 30 min. The weight gain of the fiber after the CO₂ exposure was 10.7% by weight.

Attempts to wind the CLAF-20/PAN fiber (which did not include a reinforcing thread) around a ⅜″ rod failed. Rather, the fiber broke into pieces due to bending.

### Example 3

A dope solution was prepared by mixing 21.3 g of CALF-20 powder, 7.33 g of polyacrylonitrile and 40.0 g of NMP. After degassing, the dope solution was transferred into a fiber spinning apparatus equipped with a spinneret and a polyester thread (black, TEX21, spun polyester, with a diameter of about 0.005 inch) feeder. The dope solution and the thread were extruded from a spinneret to form a nascent fiber and the nascent fiber was delivered into deionized (DI) water. The fiber was further soaked in water for 24 hours (to remove the NMP solvent), after which it was air dried.

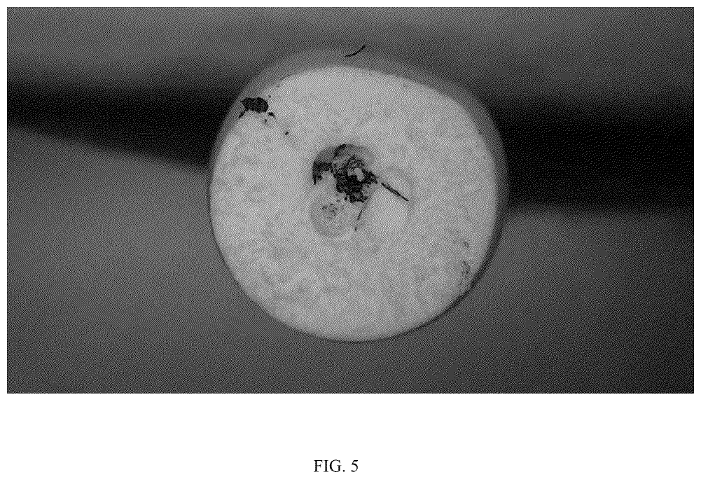

A photograph of a cross section of the fiber is presented in FIG. 5. The black region in the cross section is the cross section of the reinforcing polyester thread.

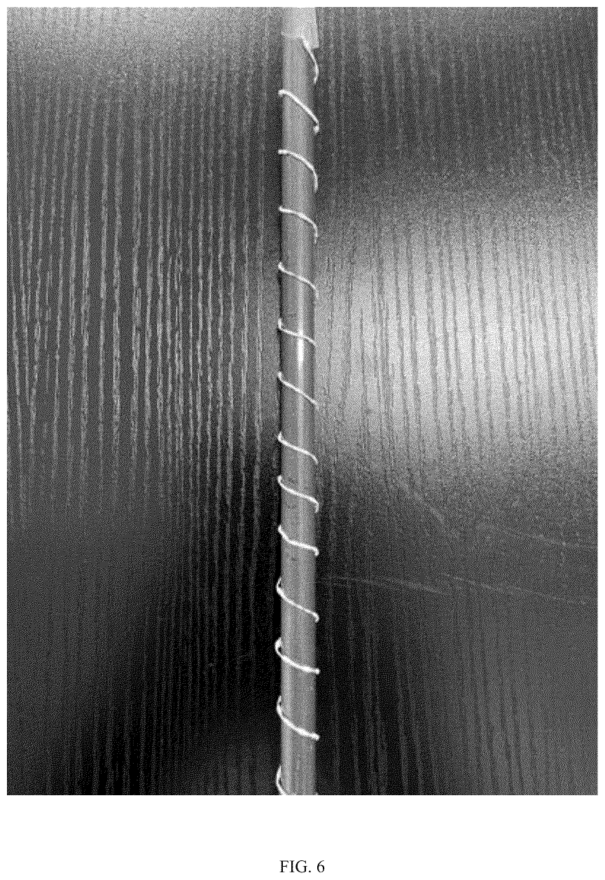

FIG. 6 shows that the pliable CALF-20/PAN fiber, reinforced with the polyester thread, could be easily wound around a ⅜″ rod.

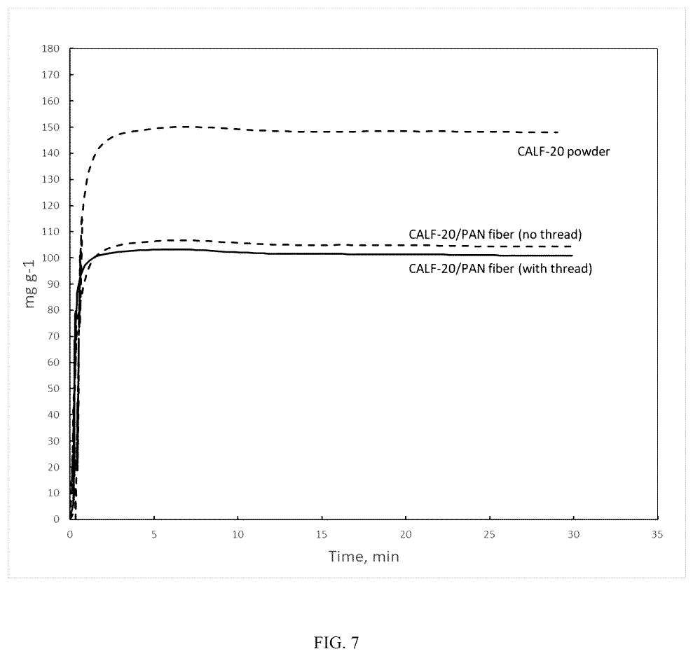

A section of the fiber was tested with a TGA instrument for its CO₂ adsorption property. The fiber was first heated to 110° C. and held at 110° C. for 30 min to activate the fiber under nitrogen. This was followed by cooling the activated fiber to 30° C. under nitrogen. The fiber was then exposed to a dry CO₂ gas stream for 30 min. The weight gain of the fiber after the CO₂ exposure was 10.4% by weight. FIG. 7 shows a comparison of pure CALF-20 powder, CALF-20/PAN fiber (no thread) and CALF-20/PAN fiber (reinforced with a polyester thread) for the pure CO₂ adsorption profile at 30° C. The results indicated that the reinforcing thread in the porous PAN matrix had no detrimental effect on adsorption capacity and kinetics when compared to the non-reinforced CALF-20 fiber. Also, both fibers (with and without reinforcing thread) performed well relative to the pure CALF-20 powder.

While this invention has been particularly shown and described with references to preferred embodiments thereof, it will be understood by those skilled in the art that various changes in form and details may be made therein without departing from the scope of the invention encompassed by the appended claims.

What is claimed is:

1. A process for removing an acid gas from a fluid stream containing the acid gas, the process comprising:
contacting the fluid stream with a reinforced porous adsorbent fiber, the reinforced porous adsorbent fiber including a reinforcing thread partially or completely embedded in a fiber adsorbent component, whereby at least a portion of the acid gas is adsorbed by the reinforced porous adsorbent fiber to produce a purified fluid stream,
wherein, the fiber adsorbent component includes an active adsorbent dispersed in a porous matrix.

2. The process of claim 1, wherein the reinforced porous adsorbent fiber is prepared by a method comprising:
co-extruding a reinforcing thread and a first solution containing a water insoluble polymer and the active adsorbent to produce a thread-reinforced nascent fiber;
directing the thread-reinforced nascent fiber to an aqueous solution to form a thread-reinforced coagulated adsorbent fiber;
optionally washing the thread-reinforced coagulated adsorbent fiber;
drying the optionally washed thread-reinforced coagulated adsorbent fiber to produce the reinforced porous adsorbent fiber; and
optionally heating the dry reinforced porous adsorbent fiber to produce a heat-treated reinforced porous adsorbent fiber.

3. The process of claim 2 wherein the first solution is prepared using a polar solvent selected from the group consisting of: DMF, DMAc, NMP, DMSO, THF, ethanol, propanol, and any mixture thereof.

4. The process of claim 2 wherein the water insoluble polymer is selected from the group consisting of polysulfone, polyimide, cellulose, polyacrylonitrile, polyvinyl difluoride, polyvinylchloride, polyvinyl butyral, and any mixture thereof.

5. The process of claim 1, wherein the active adsorbent is a polyethylenimine or wherein the active adsorbent is a polyvinylamine.

6. The process of claim 1, wherein the active adsorbent is a solid adsorbent particle selected from the group consisting of: zeolites, MOFs, COFs, PAFs, activated alumina, carbon, graphene, silica, and LDH.

7. The process of claim 1, wherein the active adsorbent is an amine appended solid adsorbent particle selected from the group consisting of: zeolites, MOFs, COFs, PAFs, activated alumina, carbon, graphene, silica, and LDH.

8. The process of claim 1, wherein the active adsorbent is a MOF based solid adsorbent particle selected from the group consisting of: CALF-20, UTSA-16, MUF-16, MIL-120(Al) and epn-Mg(dobpdc).

9. The process of claim 1, wherein the reinforcing thread is a PET, PAN, polyimide, polyamide, cotton, carbon, steel, copper, nichrome, or aluminum monofilament or braid.

10. The process of claim 1, wherein the acid gas is CO₂, SO₂ or H₂S.

11. A method for preparing a porous reinforced adsorbent fiber, the method comprising:
co-extruding a first solution and a reinforcing thread, the first solution containing a water insoluble polymer and an active adsorbent;
bringing into contact the first solution with an aqueous solution to form a solid reinforced fiber;
optionally washing the solid reinforced fiber;
drying the optionally washed solid reinforced fiber to produce a porous reinforced adsorbent fiber.

12. A porous reinforced adsorbent fiber prepared by the method of claim 11.

13. The porous reinforced adsorbent fiber of claim 12, wherein the active adsorbent is a polyethylenimine or wherein the active adsorbent is a polyvinylamine.

14. The porous reinforced adsorbent fiber of claim 12, wherein the active adsorbent is a solid adsorbent in particulate form selected from the group consisting of: zeolites, MOFs, COFs, PAFs, activated alumina, carbon, graphene, silica, and LDH.

15. The porous reinforced adsorbent fiber of claim 12, wherein the active adsorbent is an amine appended solid adsorbent in particulate form, the solid adsorbent being selected from the group consisting of: zeolites, MOFs, COFs, PAFs, activated alumina, carbon, graphene, silica, and LDH.

16. The porous reinforced adsorbent fiber of claim 12, wherein the active adsorbent is a MOF based solid adsorbent in particulate form, the MOF based solid adsorbent being selected from the group consisting of: CALF-20, UTSA-16, MUF-16, MIL-120(A1), and epn-Mg(dobpdc).

17. The porous reinforced adsorbent fiber of claim 12, wherein the reinforcing thread is a monofilament or a braided thread made of a material selected from the group consisting of: PET, PAN, polyimide, polyamide, cotton, carbon, steel, copper, nichrome and aluminum.

18. The porous reinforced adsorbent fiber of claim 12 wherein the first solution is prepared using a polar solvent selected from the group consisting of: DMF, DMAc, NMP, DMSO, THF, ethanol, propanol, and any mixture thereof.

19. The porous reinforced adsorbent fiber of claim 12 wherein the water insoluble polymer is selected from the group consisting of polysulfone, polyimide, cellulose, polyacrylonitrile, polyvinyl difluoride, polyvinylchloride, polyvinyl butyral, and any mixture thereof.
